(19) United States
(12) Patent Application Publication
(10) Pub. No.: US 2019/0077060 A1
(43) Pub. Date: Mar. 14, 2019

(54) GLASS FILLER-REINFORCED SOLID RESIN

(71) Applicant: SABIC Global Technologies B.V., Bergen op Zoom (NL)

(72) Inventors: Jong-Min Choi, Gyeonggi-do (KR); Narong An, Shanghai (CN); Liang Wang, Shanghai (CN)

(73) Assignee: SABIC Global Technologies B.V., Bergen op Zoom (NL)

(21) Appl. No.: 16/080,513

(22) PCT Filed: Mar. 2, 2017
(86) PCT No.: PCT/IB2017/000315

§ 371 Date: Aug. 28, 2018

Related U.S. Application Data
(60) Provisional application No. 62/302,279, filed on Mar. 2, 2016.

(51) Int. Cl. B29C 45/00; B29C 45/37; B29C 70/58; C08K 7/14; C08K 7/20

(52) U.S. Cl. CPC B29C 45/0013; B29C 45/372; B29K 2509/08; C08K 7/14; C08K 7/20; B29C 70/58

(57) ABSTRACT

Glass filler-reinforced solid resins and methods of making the same. The method includes contacting a flowable resin composition and a tool. The flowable resin composition includes a flowable resin and glass filler. The method includes molding or forming the flowable resin composition with the tool. The method includes curing the flowable resin composition, to form the glass filler-reinforced solid resin. Substantially all the surface of the tool that contacts the flowable resin composition during the curing thereof has a surface roughness Rₐ of about 2 microns or less. A refractive index of the glass filler is within about 0.100 of a refractive index of a cured product of the flowable resin in the glass filler-reinforced solid resin.

### CROSS-REFERENCE TO RELATED APPLICATION

This application claims the benefit of priority to U.S. Provisional Patent Application Ser. No. 62/302,279, filed Mar. 2, 2016, the disclosure of which is incorporated herein in its entirety by reference.

### BACKGROUND

Although filler-reinforced transparent resins such as glass-fiber-reinforced transparent resins can be used to produce various products requiring good optical properties such as high visible light transmittance and low haze, the optical properties of filler-reinforced resins produced using simple and widely used processing methods, such as such as injection molding, extrusion, and hot press molding, has not reached an acceptable level to replace glass and unfilled transparent resins.

### SUMMARY OF THE INVENTION

In various embodiments, the present invention provides a method of making a glass filter-reinforced solid resin. The method includes contacting a flowable resin composition and a tool. The flowable resin composition includes a flowable resin and glass filler. The glass filler and the solid resin are a substantially homogeneous mixture. The method includes molding or forming the flowable resin composition with the tool. The method includes curing the flowable resin composition, to form the glass filler-reinforced solid resin. Substantially all the surface of the tool that contacts the flowable resin composition during the curing thereof has a surface roughness Rₐ of about 2 microns or less. A refractive index of the glass filler is within about 0.100 of a refractive index of a cured product of the flowable resin in the glass filler-reinforced solid resin.

In various embodiments, the present invention provides a method of making a glass fiber-reinforced solid resin. The method includes heating a mold. The method includes contacting a flowable resin composition and the heated mold. The flowable resin composition includes a flowable resin including a bisphenol-A based polycarbonate, and poly(1,4-cyclohexylidene cyclohexane-1,4-dicarboxylate). The weight ratio of the aromatic polycarbonate to the poly(1,4-cyclohexylidene cyclohexane-1,4-dicarboxylate) in the flowable resin composition is about 30:70 to about 90:10. The flowable resin composition also includes glass fibers. The glass fibers and the solid resin are a substantially homogeneous mixture. The method includes molding the flowable resin composition with the mold. The method includes cooling the mold. The method includes curing the flowable resin composition, to form the glass fiber-reinforced solid resin. The glass fiber-reinforced resin has a transmittance at 380-780 nm at 1.5 mm thickness of about 85% to about 90%. The glass fiber-reinforced resin has a scattered transmittance at 380-780 nm at 1.5 mm thickness of about 2% to about 10%. The glass fiber-reinforced resin has a haze at 380-780 nm at 1.5 mm thickness of about 1% to about 15 The glass fiber-reinforced resin has a brightness at 1.5 mm thickness of about 1015 cd/m² to about 1050 cd/m². Substantially all the surface of the tool that contacts the flowable resin composition during the curing thereof has a surface roughness Rₐ of about 1 nm to about 2 microns. A refractive index of the glass fibers is within about 0.100 of a refractive index of a cured product of the flowable resin in the glass fiber-reinforced solid resin. The cured product of the flowable resin in the glass fiber-reinforced solid resin and the glass fibers independently have refractive indexes of about 1.500 to about 1.600.

In various embodiments, the present invention provides a method of making a glass filler-reinforced solid resin. The method includes heating a tool. The method includes contacting a flowable resin composition and the heated tool. The flowable resin composition includes a flowable resin and glass filler. The glass filler and the solid resin are a substantially homogeneous mixture. The method includes molding or forming the flowable resin composition with the tool. The method includes cooling the tool. The method includes curing the flowable resin composition, to form the glass filler-reinforced solid resin. A refractive index of the glass filler is within about 0.100 of a refractive index of a cured product of the flow b e resin in the glass filler-reinforced solid resin.

In various embodiments, the present invention provides a glass filler-reinforced solid resin. The glass filler-reinforced solid resin includes a solid resin having a refractive index. The glass filler-reinforced solid resin includes glass filler having a refractive index, wherein the glass filler and the solid resin are a substantially homogeneous mixture, wherein the refractive index of the solid resin is within about 0.100 of the refractive index of the glass filler. The glass filler-reinforced solid resin has a transmittance at 380-780 nm at 1.5 mm thickness of about 80% to about 95%. The glass filler-reinforced solid resin has a scattered transmittance at 380-780 nm at 1.5 mm thickness of about 0.2% to about 20%. The glass filler-reinforced solid resin has a haze at 380-780 nm at 1.5 mm thickness of about 0.2% to about 20%. The glass filler-reinforced solid resin has a brightness at 1.5 mn thickness of about 1000 cd/m² to about 1100 cd/m².

In various embodiments, the present invention provides a glass fiber-reinforced solid resin. The glass fiber-reinforced solid resin includes a solid resin having a refractive index, the solid resin including a cured product of a bisphenol A-based polycarbonate and poly(1,4-cyclohexylidene cyclohexane-1,4-dicarboxylate), wherein the weight ratio of the aromatic polycarbonate to the poly(1,4-cyclohexylidene cyclohexane-1,4-dicarboxylate) in the solid resin is about 30:70 to about 90:10. The glass fiber-reinforced solid resin includes glass fibers having a refractive index, wherein the glass fibers and the solid resin are a substantially homogeneous mixture. The refractive index of the solid resin is within about 0.100 of the refractive index of the glass fibers. The solid resin and the glass fibers independently have refractive indexes of about 1.500 to about 1.600. The glass fiber reinforced solid resin has a transmittance at 380-780 nm at 1.5 mm thickness of about 85% to about 90%. The glass fiber reinforced, solid resin has a scattered transmittance at 380-780 nm at 1.5 mm thickness of about 2% to about 10%. The glass fiber reinforced solid resin has a haze at 380-780 nm at 1.5 mm thickness of about 1% to about 15%. The glass fiber reinforced solid resin has a brightness at 1.5 mm thickness of about 1015 cd/m² to about 1050 cd/m².

In various embodiments, the present invention provides certain advantages over other methods and filler-reinforced resins, at least some of which are unexpected. For example, in various embodiments, the present invention provides a filler-reinforced resin having better optical characteristics than other filler-reinforced resins, such as better higher transmission, higher brightness, lower scattered transmittance, and lower haze. In various embodiments, the present invention provides a filler-reinforced resin with a more homogeneously distributed filler therein and having a smoother surface, at least partially avoiding the tendency of filler to float or accumulate at interfaces between the resin and a mold cavity surface and to thereby cause high surface roughness of the finished product. In various embodiments, the present invention provides a method of making a filler-reinforced resin having better optical characteristics than other filler-reinforced resins that can be carried out using normal processing methods, such as injection molding, extrusion, and hot press molding.

In various embodiments, the present invention provides a filler-reinforced resin that can replace glass or transparent resins in various applications, while providing better physical properties, such as greater strength, less brittleness, higher chemical resistance, lower yellowness index, or a combination thereof. In various embodiments, as compared to glass, the filler-reinforced solid, resin can have less brittleness, lighter weight, or a combination thereof. In various embodiments, as compared to transparent unfilled resins, the filler-reinforced solid resin can have greater strength, lower coefficient of thermal expansion (CTE), less shrinkage, higher thermal resistance, greater surface hardness, or a combination thereof. In various embodiments, as compared to transparent unfilled resins, the filler-reinforced solid resin can be better for hybrid design or 2K (e.g., “two-shot”) molding.

### BRIEF DESCRIPTION OF THE FIGURES

The drawings illustrate generally, by way of example, but not by way of limitation, various embodiments discussed in the present document.

FIG. 1 illustrates injection molding tooling, in accordance with various embodiments.

FIG. 2 illustrates injection molding tooling cross section and molded part, in accordance with various embodiments.

FIG. 3A is a photograph illustrating a sample prepared without any heating and cooling, in accordance with various embodiments.

FIG. 3B is a photograph illustrating a sample prepared with single-sided heating and cooling, in accordance with various embodiments.

FIG. 3C is a photograph illustrating a sample prepared with double-sided heating and cooling.

FIG. 4A illustrates total transmittance at 1.5 mm thickness for various injection molded samples, in accordance with various embodiments.

FIG. 4B illustrates total transmittance for an injection molded sample at various thicknesses, in accordance with various embodiments.

FIG. 4C illustrates the total transmittance including scattered transmittance by wavelength for various samples, in accordance with various embodiments.

FIG. 5A illustrates scattered transmittance at 1.5 mm thickness for various injection molded samples, in accordance with various embodiments.

FIG. 5B illustrates scattered transmittance of an injection molded sample at various thicknesses, in accordance with various embodiments.

FIG. 5C illustrates scattered transmittance for various samples at various thicknesses, in accordance with various embodiments.

FIG. 6A illustrates haze at 1.5 mm thickness for various injection molded samples, in accordance with various embodiments.

FIG. 6B illustrates haze of an injection molded sample at various thicknesses, in accordance with various embodiments.

FIG. 6C illustrates haze for various samples having various thicknesses, in accordance with various embodiments.

FIG. 7 illustrates the average brightness at 1.5 mm thickness for various injection molded samples, in accordance with various embodiments.

FIG. 8 illustrates calculated transmittance and haze for various injection molded samples, in accordance with various embodiments.

FIGS. 9A-B illustrate the surface roughness of one side of the tooling used to form various samples, with FIG. 9A showing the X-profile and with FIG. 9B showing the Y-profile, in accordance with various embodiments.

FIGS. 9C-D illustrate the surface roughness of the other side of the tooling used to form various samples, with FIG. 9C showing the X-profile and with FIG. 9D showing the Y profile, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1 to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%. 70%, 80%, 90%, 95%, 96%, 97%, 98%, 99%, 99.5%, 99.9%,99.99%, or at least about 99.999% or more, or 100%.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation. The term “UV light” as used herein refers to ultraviolet light, which is electromagnetic radiation with a wavelength of about 10 nm to about 400 nm.

The term “cure” as used herein refers to exposing to radiation in any form, heating, or allowing to undergo a physical or chemical reaction that results in hardening or an increase in viscosity. A flowable thermoplastic material can be cured by cooling it such that the material hardens. A flowable thermoset material can be cured by heating or otherwise exposing to irradiation such that the material hardens.

The term “pore” as used herein refers to a depression, slit, or hole of any size or shape in a solid object. A pore can run all the way through an object or partially through the object. A pore can intersect other pores. A pore can be produced by a pulsed laser source.

The term “groove” as used herein refers to a depression, slit, or hole having a greater length than width in a solid object. A groove can intersect other grooves. A groove can be produced by a continuous laser source.

The term “room temperature” as used herein refers to a temperature of about 15° C. to 28° C.

The term “coating” as used herein refers to a continuous or discontinuous layer of material on the coated surface, wherein the layer of material can penetrate the surface and can fill areas such as pores or grooves, wherein the layer of material can have any three-dimensional shape, including a flat or curved plane. In one example, a coating can be formed on one or more surfaces, any of which may be porous or nonporous, by immersion in a bath of coating material.

The term “surface” as used herein refers to a boundary or side of an object, wherein the boundary or side can have any perimeter shape and can have any three-dimensional shape, including flat, curved, or angular, wherein the boundary or side can be continuous or discontinuous.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

As used herein, the term “injection molding” refers to a process for producing a molded part or form by injecting a composition including one or more polymers that are thermoplastic, thermosetting, or a combination thereof, into a mold cavity, where the composition cools and hardens to the configuration of the cavity. Injection molding can include the use of heating via sources such as steam, induction, cartridge heater, or laser treatment to heat the mold prior to injection, and the use of cooling sources such as water to cool the mold after injection, allowing faster mold cycling and higher quality molded parts or forms.

### Method of Making a Glass Filler-Reinforced Solid Resin

The present invention provides a method of making a glass-fiber reinforced solid resin. The method includes contacting a flowable resin composition and a tool. The flowable resin composition includes a flowable resin and glass filler. The glass filler and the solid resin are a substantially homogeneous mixture. The flowable resin composition can be formed by heating a resin composition including the glass filler to a sufficient temperature such that the resin composition becomes flowable (e.g., above the melting point of the flowable resin in the flowable resin composition, above the glass transition temperature of the flowable resin, or above the heat deflection temperature of the flowable resin). The method can include molding or forming the flowable resin composition with the tool. The method can include curing the flowable resin composition, to form the glass filler-reinforced solid resin. A refractive index of the glass filler can be within about 0.100 of a refractive index of a cured product of the flowable resin in the glass filler-reinforced solid resin.

In some embodiments, substantially all the surface of the tool that contacts the flowable resin composition during the curing thereof has a surface roughness Rₐ (i.e., the arithmetic average of vertical deviations from the mean height of the surface) of about 2 microns or less. Substantially all the surface of the tool that contacts the flowable resin composition during the curing can be free of surface roughness greater than about 2 microns. A smoother surface can result in better optical properties of the glass-fiber reinforced solid resin, such as higher transmittance, lower scattered transmittance, lower haze, and higher brightness. The surface of the tool that contacts the flowable resin composition during the curing can have a surface roughness Rₐ of about 2 microns or less (e.g., with the surface that contacts the flowable resin during the curing being free of surface roughness higher than the maximum surface roughness specified), about 1 nm to about 50 microns, about 1 nm to about 2 microns, about 0.1 nm to about 50 nm, about 1 nm to about 10 nm, or greater than, equal to, or less than about 20 microns, 18, 16, 14, 12, 10, 9, 8, 7, 6, 5, 4, 3, 2, 1, 0.9, 0.8, 0.7, 0.6, 0.5, 0.4, 0.3, 0.2 microns, 100 nm, 90 nm, 80, 70, 60, 50, 40, 35, 30, 25, 20, 18, 16, 15, 14, 13, 12, 11, 10, 9, 8, 7, 6, 5, 4, 3, 2, 1, 0.5 nm, or about 0.1 nm or less. The surface of the tool that contacts the flowable resin composition during the curing can have a surface roughness VDI 3400 of about 26 or more, such as less then, equal to, or greater than about 25, 24, 23, 22, 21, 20, 19, 18, 17, 16, 15, 14, 13, 12, 11, 10, 9, 8, 7, 6, 5, 4, 3, 2, 1, 0, 0,1, 0,01, or about 0.001 or less. The surface of the tool that contacts the flowable resin composition during the curing can have a surface roughness of about B3 or higher in USA SPI (society of plastic industry) standard, or less polished than, equally polished to, or more polished than about B2, B1, A3, A2, or about A1 or more.

The refractive index (i.e., a dimensionless number that describes how light propagates through a medium, equal to the speed of light divided by the phase velocity of light in the medium) of the glass filler in the flowable resin composition can be within about 0.100 of a refractive index of a cured product of the flowable resin in the glass filler-reinforced solid resin. The refractive index of the flowable resin can be about the same as the refractive index of a cured product of the flowable resin in the glass filler-reinforced solid resin. The difference between the refractive index of the glass filler and the cured product of the flowable resin can be any suitable difference (e.g., with the flowable resin composition being free of glass filler and flowable resin having a greater difference in refractive index than that specified), such as greater than, equal to, or less than about 0.100, 0.95, 0.9, 0.85, 0.8, 0.75, 0.7, 0.65, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.09, 0.08, 0.07, 0.06, 0.05, 0.04, 0.035, 0.03, 0.025, 0.02, 0.015, 0.01, 0.005, or about 0.001 or less.

The method includes contacting the flowable resin composition and a tool, and molding or forming the flowable resin composition with the tool. The method also includes curing the flowable resin composition to form the glass filler-reinforced solid resin, such as by cooling (e.g., with a thermoplastic flowable resin, below the melting point or below the glass transition temperature of the flowable resin, or below the heat deflection temperature of the flowable resin), by heating or otherwise exposing to radiation (e.g., with a thermoset flowable rest), or a combination thereof. The method can also include removing the glass filler-reinforced solid resin from the tool.

The contacting, molding or forming, and curing can include (e.g., can be or can be part of a process such as) injection molding (e.g., injecting the flowable resin composition into a mold), extrusion (e.g., extruding the flowable resin composition from an extruder), thermal lamination (e.g., flowable resin composition is laminated), hot pressing (resin composition is pressed with heating until resin composition becomes flowable resin composition, which can be formed into a desired shape via the pressing), hot forming (e.g., resin composition is heated until resin composition becomes flowable resin composition, which is then formed into a desired shape), or a combination thereof. The tool can be any suitable tool. The tool can be a roller, a press, a mold, an extruder, or a combination thereof. The tool can be a mold. In some embodiments, at least part of the surface of the tool that contacts the flowable resin composition can include a coating, such as to prevent bonding of the flowable resin to the tool during curing.

The method can include heating the tool prior to the contacting of the flowable resin composition and the tool, to provide a heated tool, wherein contacting the flowable resin composition and the tool includes contacting the flowable resin composition and the heated tool. The heating can include heating to any suitable temperature, such as a temperature greater than the melting point of the flowable resin, greater than the glass transition temperature of the flowable resin, or greater than the heat deflection temperature of the flowable resin. The heating can be performed in any suitable way, such as by flowing hot medium through conduits in the tool (e.g., steam, compressed steam), induction, cartridge heater, or laser treatment. The heating can be performed by contacting a heated medium to the tool, such as via conduits therein. The heated medium can be any suitable heated medium, such as heated water (e.g., water vapor), an oil, or a gas.

The method can include cooling the tool during the molding or forming of the flowable resin composition, during the curing of the flowable resin composition, or a combination thereof. The cooling can be to any suitable temperature, such as to a temperature below the melting point of the flowable resin, below the glass transition temperature of the flowable resin, below the heat deflection temperature of the flowable resin, to a temperature near room temperature, or to an ejection temperature. The cooling can be performed by contacting a cooled medium to the tool, such as via conduits therein. The cooled medium can be any suitable cooled medium, such as water, an oil, or a gas. Heating or cooling conduits can be situated such that the center of the conduits is no more than 2*D from the surface of the tool that contacts the flowable resin composition, wherein D is the diameter of the conduit. The conduits can have a distance therebetween of no more than 3*D. The method can include both heating the tool prior to the contacting and cooling the tool (e.g., heat and cool, H&C, RHCM, or HCM, E-mold, and the like). The heating and cooling can independently be side-sided (e.g., only one side of a mold is heated or cooled) or double-sided (e.g., both sides of a mold are heated or cooled).

In some embodiments, the method includes heating of the mold, cooling of the mold, or a combination thereof, with a maximum surface roughness of portions of the tool surface that contact the curing flowable resin composition. In some embodiments, the method does not require (but can include) heating of the mold or cooling of the mold, but the method does include heating and cooling of the mold.

The flowable resin composition can include any suitable material in addition to the flowable resin and the glass filler. For example, in various embodiments, the flowable resin composition further includes one or more fillers in addition to the glass filler. In some embodiments, the one or more additional fillers can have refractive indexes matched to the refractive index of the flowable resin, while in other embodiments the additional filler can have any suitable refractive index. The one or more additional fillers can form about 0.001 wt % to about 50 wt % of the flowable resin composition, or about 0.01 wt % to about 30 wt %, or about 0.001 wt % or less, or about 0.01 wt %, 0.1, 1, 2, 3, 4, 5, 10, 15, 20, 25, 30, 35, 40, 45 wt %, or about 50 wt % or more. The additional filler can be homogeneously distributed in the flowable resin composition. The additional filler can be fibrous or particulate. The additional filler can be aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as welt as additional fillers such as mica, clay, feldspar, flue dust, fillite, quartz, quartzite, perlite, Tripoli, diatomaceous earth, carbon black, or the like, or combinations including at least one of the foregoing fillers. The additional filler can be talc, kenaf fiber, or combinations thereof. The additional filler can be coated with a layer of metallic material to facilitate conductivity, or surface treated with silanes, siloxanes, or a combination of silanes and siloxanes to improved adhesion and dispersion with the flowable resin composition. The additional filler can be selected from carbon fibers, a mineral fillers, or combinations thereof. The additional filler can be is selected from mica, talc, clay, wollastonite, zinc sulfide, zinc oxide, carbon fibers, ceramic-coated graphite, titanium dioxide, or combinations thereof.

### Flowable Resin.

The flowable resin composition includes a flowable resin. The flowable resin can include any suitable one or more curable resins. The flowable resin can be a thermoplastic, a thermoset, or a combination thereof. Curing the flowable resin can include cooling the flowable resin composition such that it solidifies (e.g., in the case of a thermoplastic flowable resin), heating the flowable resin such that it solidifies (e.g., in the case of a thermoset flowable resin), or a combination thereof.

The flowable resin can be any suitable proportion of the flowable resin composition. For example, the flowable resin can be about 50 wt % to about 99.999 wt % of the flowable resin composition, about 60 wt % to about 95 wt %, or about 50 wt % or less, or less than, equal to, or greater than about 60 wt %, 62, 64, 66, 68, 70, 72, 74, 76, 78, 80, 82, 84, 86, 88, 90, 91, 92, 93, 94, 95, 96, 97, 98, 99, 99.9, 99.99, or about 99.999 wt % or more.

The one or more curable resins in the flowable resin can be any one or more curable resins, such as an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAT), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). The flowable resin composition can include polycarbonate (PC), acrylonitrile butadiene styrene (ABS), polybutylene terephthalate (PBT), polyethylene terephthalate (PET), polyetherimide (PEI), poly(p-phenylene oxide) (PPO), polyamide (PA), polyphenylene sulfide (PPS), polyethylene (PE) (e.g., ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), or a combination thereof.

The flowable resin can include (e.g., the curable resins can be) an aromatic polycarbonate and poly(1,4-cyclohexylidene cyclohexane-1,4-dicarboxylate) (PCCD). The aromatic polycarbonate can be any suitable aromatic polycarbonate, such as a polycarbonate, derived from a bisphenol (e.g., a compound containing two hydroxyphenyl functionalities). The bisphenol can be chosen from bisphenol A (2,2-bis(4-hydroxyphenyl)propane), bisphenol AP (1,1-bis(4-hydroxyphenyl)-1-phenyl-ethane), bisphenol AF (2,2-bis(4-hydroxyphenyl)hexafluoropropane), bisphenol B (2,2-bis(4-hydroxyphenyl)butane), bisphenol BP (bis-(4-hydroxyphenyl)diphenylmethane), bisphenol C (2,2-bis(3-methyl-4-hydroxyphenyl)propane), bisphenol E (1,1-bis(4-hydroxyphenyl)ethane), bisphenol F (his(4-hydroxydiphenyl)methane), bisphenol G (2,2-bis(4-hydroxy-3-isopropyl-phenyl)propane), bisphenol PH (5,5′-(1-methylethyliden)-bis[1,1′-(bisphenyl)-2-ol]propane), bisphenol TMC (1,1-bis(4-hydroyphenyl)-3,3,5-trimethyl-cyclohexane), bisphenol Z (1,1-bis(4-hydroxyphenyl)-cyclohexane), and combinations thereof. The bisphenol can be bisphenol A (2,2-bis(4-hydroxyphenyl)propane). The aromatic polycarbonate can be a bisphenol A-based polycarbonate (e.g., a polycarbonate derived from reaction of bisphenol A and phosgene, such as a poly(oxycarbonyloxy-1,4-phenylene(1-methylethylidene)-1,4-phenylene). The flowable resin can include a bisphenol A-based polycarbonate and poly(1,4-cyclohexylidene cyclohexane-1,4-dicarboxylate). The weight ratio of the aromatic polycarbonate to the poly(1,4-cyclohexylidene cyclohexane-1,4-dicarboxylate) in the flowable resin can be any suitable weight ratio, such as about 5:95 to about 95:5, about 30:70 to about 90:10, about 70:30 to about 60:40, or about 5:95 or less, or about 10:90, 15:85, 20:80, 25:75, 30:70, 35:65, 40:60, 45:55, 50:50, 55:45, 60:40, 65:35, 70:30, 75:25, 80:20, 85:15, 90:10, or about 95:5 or more. The refractive index of the aromatic polycarbonate (e.g. of a cured product thereof) can be within 0.100 of the refractive index of the poly(1,4-cyclohexylidene cyclohexane-1,4-dicarboxylate) (e.g., of a cured product thereof), or the difference can be greater than, equal to, or less than about 0.100, 0.95, 0.9, 0.85, 0.8, 0.75, 0.7, 0.65, 0.6, 0.58, 0.56, 0.54, 0.52, 0.5, 0.48, 0.46, 0.44, 0.42, 0.4, 0.38, 0.36, 0.34, 0.32, 0.3, 0.28, 0.26, 0.24, 0.22, 0.2, 0.18, 0.16, 0.14, 0.12, 0.1, 0.09, 0.08, 0.07, 0.06, 0.05, 0.04, 0.035, 0.03, 0.025, 0.02, 0.015, 0.01, 0.005, or about 0.001 or less.

The cured product of the flowable resin can have any suitable refractive index. In some embodiments, the cured product of the flowable resin in the glass filler-reinforced solid resin (e.g. only the cured product, not including the glass filler or other ingredients therein) can have about the same refractive index as the flowable resin. In other embodiments, the refractive index of the flowable resin can change upon curing. The refractive index of the cured product of the flowable resin can be about 1.450 to about 1.800, or about 1.500 to about 1.600, about 1.508 to about 1.585, about 1.540 to about 1.570, or about 1.450 or less, or less than, equal to, or greater than about 1.455, 1.460, 1.465, 1.470, 1.475, 1.480, 1.485, 1.490, 1.495, 1.500, 1.505, 1.510, 1.515, 1.520, 1.525, 1.530, 1.535, 1.540, 1.545, 1.550, 1.555, 1.560, 1.565, 1.570, 1.575, 1.580, 1.585, 1.590, 1.595, 1.600, 1.605, 1.610, 1.615, 1.620, 1.625, 1.630, 1.635, 1.640, 1.645, 1.650, 1.660, 1.670, 1.680, 1.690, 1.700, 1.710, 1.720, 1.730, 1.740, 1.750 1.760, 1.770, 1.780, 1.790, or about 1.800 or more.

### Glass Filler.

The flowable resin composition includes glass filler. The flowable resin composition can include one type of glass filler, or more than one type of glass filler. The one or more glass fillers can form any suitable proportion of the flowable resin composition, such as about 0.001 wt % to about 50 wt % of the flowable resin composition, about 5 wt % to about 40 wt %, or about 0.001 wt % or less, or less than, equal to, or greater than about 0.01 wt %, 0.1 wt %, 1, 2, 3, 4, 5, 6, 7, 8, 9, 10, 12, 14, 16, 18, 20, 22, 24, 26, 28, 30, 32, 34, 36, 38, 40, 42, 44, 46, 48, or about 50 wt % or more,

The glass filler can be glass beads, glass flakes, glass fibers (e.g., having any suitable profile, such as a round or flat profile), or any combination thereof. The glass filler can have any suitable profile, such as a round of flat profile. For example, the glass filler can be glass fibers having a round (e.g., rod-shaped) or flat profile.

The glass filler can include any suitable type of glass (e.g., silica-based glass, such as silicate glass), such as soda-lime glass, fused silica glass (e.g., quartz glass), borosilicate glass (e.g., sodium borosilicate glass, non-alkali metal-based borosilicate glass, alkali earth metal-based borosilicate glass), lead-oxide glass (e.g., alkali lead silicate glass), aluminosilicate glass, oxide glass, glass with high zirconia content, or a combination thereof.

The glass filler can have any suitable dimensions. The glass filler can have a largest dimension of about 0.1 microns or less, or less than, equal to, or greater than about 0.5 microns, 0.1, 0.2, 0.4, 0.6, 0.8, 1, 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90 microns, 0.1 mm. 0.2, 0.4, 0.6, 0.8, 1, 2, 3, 4, 5, 6, 7, 8, 10, 12, 14, 16, 18, 20, 25, 30, 35, 40, 45, 50, 60, 70, 80, 90, 100, 125, 150, 175, 200, 225, 250, or about 500 mm or more.

Glass fibers can have any suitable dimensions. The glass fibers can have a length of about 0.1 mm to about 500 mm, about 0.1 mm to about 100 mm, about 0.5 mm to about 50 mm, about 1 mm to about 5 mm, or about 0.1 mm or less, or less than, equal to, or greater than about 0.2. mm, 0 4, 0.6, 0.8, 1, 2, 3, 4, 5, 6, 8, 10, 12, 14, 16, 18, 20, 25, 30, 35, 40, 45, 50, 60, 70, 80, 90, 100, 125, 150, 175, 200, 225, 250, or about 500 mm or more.

Glass fibers can have a diameter of about 0.01 mm to about 10 mm in diameter, about 0.1 to about 5 mm in diameter, or about 0.1 microns or less, or less than, equal to, or greater than about 0.5 microns, 0.1, 0.2, 0.4, 0.6, 0.8, 1, 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90 microns, 0.1 mm, 0.2., 0.4, 0.6, 0.8, 1, 2, 3, 5, 6, 7, 8, 9 mm, or about 10 mm or more.

The glass filler can have any suitable refractive index. The refractive index of the glass filler can be about 1.450 to about 1.800, or about 1.500 to about 1.600, about 1.508 to about 1.585, about 1.540 to about 1.570, or about 1.450 or less, or less than, equal to, or greater than about 1.455, 1.460, 1.465, 1.470, 1.475, 1.480, 1.485, 1.490, 1.495, 1.500, 1.505, 1.510, 1,515, 1.520, 1.525, 1.530, 1.535, 1.540, 1.545, 1.550, 1.555, 1.560, 1.565, 1.570, 1.575, 1.580, 1.585, 1.590, 1.595, 1.600, 1.605, 1.610, 1.615, 1.620, 1.625, 1.630, 1.635, 1.640, 1.645, 1.650, 1.660, 1.670, 1.680, 1.690, 1.700, 1.710, 1.720, 1.730, 1.740, 1.750, 1.760, 1.770, 1.780, 1.790, or about 1.800 or more,

### Glass Filler-Reinforced Solid Resin.

The present invention provides a glass filler-reinforced, solid resin. The glass filler-reinforced solid resin can be any suitable glass filler-reinforced solid resin that can be made by an embodiment of the method described herein for forming the glass filler-reinforced solid resin. For example, the glass filler-reinforced solid resin can be a cured product of an embodiment of the flowable resin composition described herein. The glass filler-reinforced solid resin can include a solid resin having a refractive index (e.g., a cured product of an embodiment of the flowable resin described herein). The glass filler-reinforced solid resin can include glass filler having a refractive index. The glass filler and the solid resin can be a substantially homogeneous mixture. The refractive index of the solid resin can be within about 0.100 of the refractive index of the glass filler.

The glass filler-reinforced solid resin can have any suitable surface roughness, which can correlate to the surface roughness of a tool surface that contacted a flowable resin composition as it cured to form the glass filler-reinforced solid resin. The glass filler-reinforced solid resin can have a surface roughness of about 2 microns or less (e.g., with the surface that contacts the flowable resin during the curing being free of surface roughness higher than the maximum surface roughness specified), about 1 nm to about 50 micron, about 1 nm to about 10 microns, about 0.1 nm to about 50 nm, about 1 nm to about 10 nm, or greater than, equal to, or less than about 50 microns, 40, 30, 20, 18, 16, 14, 12, 10, 9, 8, 7, 6, 5, 4, 3, 2, 1, 0.9, 0.8, 0.7, 0.6, 0.5, 0.4, 0.3, 0.2 microns, 100 nm, 90 nm, 80, 70, 60, 50, 40, 35, 30, 25, 20, 18, 16, 15, 14, 13, 12, 11, 10, 9, 8, 7, 6, 5, 4, 3, 2, 1, 0.5 nm, or about 0.1 nm or less. The glass filler-reinforced solid resin can have a surface roughness VDI 3400 of about 26 or more, such as less then, equal to, or greater than about 25, 24, 23, 22, 21, 20, 19, 18, 17, 16, 15, 14, 13, 12, 11, 10, 9, 8, 7, 6, 5, 4, 3, 2, 1, 0, 0.1, 0.01, or about 0.001 or less. The glass filler-reinforced solid resin can have a surface roughness of about B3 or higher in USA SPI (society of plastic industry) standard, or less polished than, equally polished to, or more polished than about B2, B1, A3, A2, or about A1 or more.

The glass filler-reinforced solid resin can have any suitable refractive index, such as about 1.450 to about 1.800, or about 1.500 to about 1.600, about 1.508 to about 1.585, about 1.540 to about 1.570, or about 1.450 or less, or less than, equal to, or greater than about 1.455, 1.460, 1.465, 1.470, 1.475, 1.480, 1.485, 1.490, 1,495, 1.500, 1.505, 1.510, 1.515, 1.520, 1.525, 1.530, 1.535, 1.540, 1.545, 1.550, 1.555, 1.560, 1.565, 1.570, 1.575, 1.580, 1.585, 1.590, 1,595, 1.600, 1.605, 1,610, 1.615, 1.620, 1.625, 1.630, 1.635, 1.640, 1.645, 1.650, 1.660, 1.670, 1.680, 1.690, 1.700, 1.710, 1.720, 1.730, 1.740, 1.750, 1.760, 1.770, 1.780, 1.790, or about 1.800 or more.

The solid resin can form any suitable proportion of the glass filler-reinforced solid resin, such as about 50 wt % to about 99.999 wt %, about 60 wt % to about 95 wt %, or about 50 wt % or less, or less than, equal to, or greater than about 60 wt %, 62, 64, 66, 68, 70, 72, 74, 76, 78, 80, 82, 84, 86, 88, 90, 91, 92, 93, 94, 95, 96, 97, 98, 99, 99.9, 99.99, or about 99.999 wt % or more.

The glass filler can form any suitable proportion of the glass filler-reinforced solid resin, such as about 0.001 wt % to about 50 wt % of the flowable resin composition, about 5 wt % to about 40 wt %, or about 0.001 wt % or less, or less than, equal to, or greater than about 0.01 wt %, 0.1 wt %, 1, 2, 3, 4, 5, 6, 7, 8, 9, 10, 12, 14, 16, 18, 20, 22, 24, 26, 28, 30, 32, 34, 36, 38, 40, 42, 44, 46, 48, or about 50 wt % or more.

The glass filler-reinforced solid resin can have any suitable transmittance (indicating total transmittance herein unless otherwise indicated, the total amount of transmitted light including both collimated transmittance and scattered transmittance), such as a transmittance at 380-780 nm at 1.5 mm thickness of about 80% to about 95%, about 85% to about 90%, or about 80% or less, or less than, equal to, or greater than about 81, 82, 83, 84, 85, 86, 87, 88, 89, 90, 91, 92, 93, 94, 95.

The glass filler-reinforced solid resin can have any suitable scattered transmittance (e.g., proportion of transmitted light that is not parallel to the incident beam), such as a scattered transmittance at 380-780 nm at 1.5 mm thickness of about 0.2% to about 20%, about 2% to about 10%, or about 0.2 or less, or less than, equal to, or greater than about 0.3, 0.4, 0.5, 0.6, 0.8, 1, 1.2, 1.4, 1.6, 1.8, 2, 2.5, 3, 3.5, 4, 4.5, 5, 6, 7, 8, 9, 10, 11, 12, 13, 14, 15, 16, 17, 18, 19%, or about 20% or more.

The glass filler-reinforced solid resin can have any suitable haze (e.g., the proportion of the total transmittance that is scattered transmittance), such a haze at 380-780 nm at 1.5 mm thickness of about 0.2% to about 20%, about 1% to about 15%, or about 0.2% or less, or less than, equal to, or greater than about 0.3%, 0.4, 0.5, 0.6, 0.8, 1, 1.2, 1.4, 1.6, 1.8, 2, 2.5, 3, 3.5, 4, 4.5, 5, 6, 7, 8, 9, 10, 11, 12, 13, 14, 15, 16, 17, 18, 19%, or about 20% or more.

The glass filler-reinforced solid resin can have any suitable brightness at 1.5 mm thickness of about 1000 cd/m² to about 1100 cd/m², about 1015 cd/m² to about 1050 cd/m², or about 1000 cd/m² or less, or less than, equal to, or greater than about 1005 cd/m², 1010, 1015, 1020, 1025, 1030, 1035, 1040, 1045, 1050, 1055, 1060, 1065, 1070, 1075, 1080, 1085, 1090, 1095 cd/m², or about 1100 cd/m² or more.

The glass filler-reinforced solid resin can be any suitable application, such as in windows of transportation vehicles (e.g., car sunroof or quarter window), mobile device components (e.g., plastic front window), TV components (e.g., display, display bezel), transparent displays, or in any application where glass can be used.

### EXAMPLES

Various embodiments of the present invention can be better understood by reference to the following Examples which are offered by way of illustration. The present invention is not limited to the Examples given herein.

### Example 1

### Formation of Samples

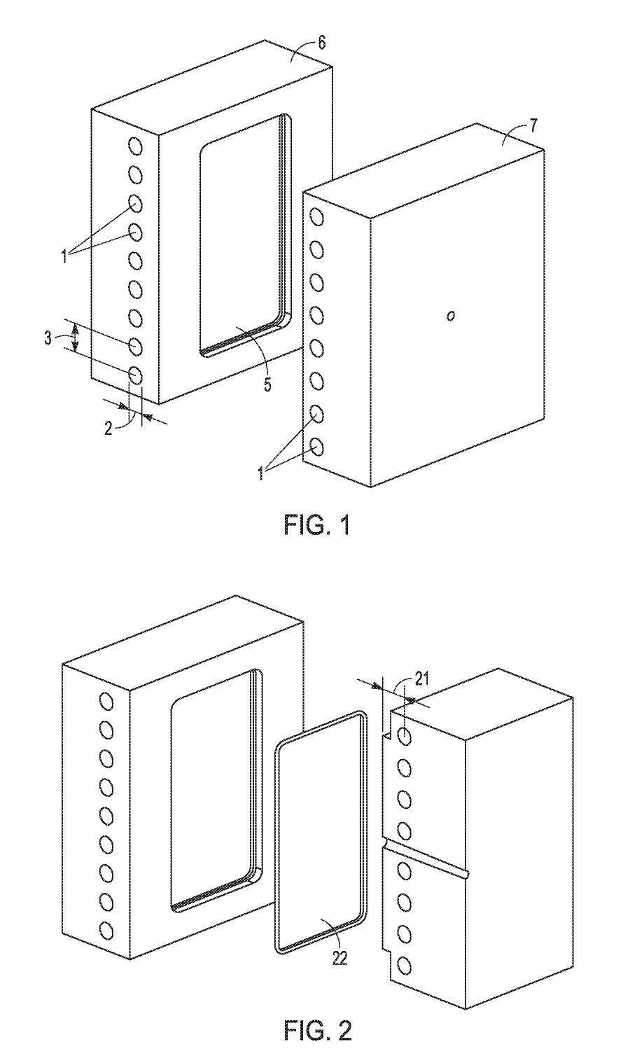

Double-sided dynamic temperature control injection molding tooling was polished using machining by grinder or end-mill, polishing wetstone from rough to smooth (from #1500 to #3000), then sand paper from rough to smooth (from #2000 to 3000), then lastly diamond compound #2 from Universal Superabrasives, USA. The final polished tooling had a smoothness of about Rₐ 6.5 nanometers. The tooling is illustrated in FIG. 1, with sides 6 and 7. The diameter 2 of the heating/cooling channels 1 was about 8 mm. The center of the heating/cooling channels 1 were located about 8 mm from the tool core surface 5. The distance 3 between the heating/cooling channels was about 16 mm. FIG. 2 shows a cross section of the molding tooling, showing molded part 22. The distance 21 was about 8 mm.

The injection molding tooling was used to generate a flat injection molded form using a glass fiber-filled 65:35 by weight mixture of bisphenol-A based polycarbonate having a refractive index of 1.586 and poly(1,4-cyclohexylidene cyclohexane-1,4-dicarboxylate) having a refractive index of 1.510. The composition had about 30 wt % chopped glass fibers from NEG that were about 3 mm in length and about 13 microns in diameter, having a refractive index of about 1.567. The injection molding tooling was used to generate 3 samples: Sample 1 without any heating and cooling of the tooling, Sample 2 with one-sided heating and cooling of the tooling, Sample 3 with double-sided heating and cooling of the tooling. Another Sample was prepared using the same procedure as used for Sample 3, but using Lexan™ LSI, which is an unfilled polycarbonate resin with no glass fibers, including UV stabilizer and mold release additives. The composition was injected into the mold at 280° C. For the procedure that included heating and cooling, prior to the injection of the composition the tooling was heated to about 130° C. using compressed steam. After injection of the composition, the tooling was held at about 130° C. for about 3-4 seconds, after which the tooling was cooled using water over a period of about 30 seconds. Once the tooling reached about 80° C. the completed Sample was removed from the tooling.

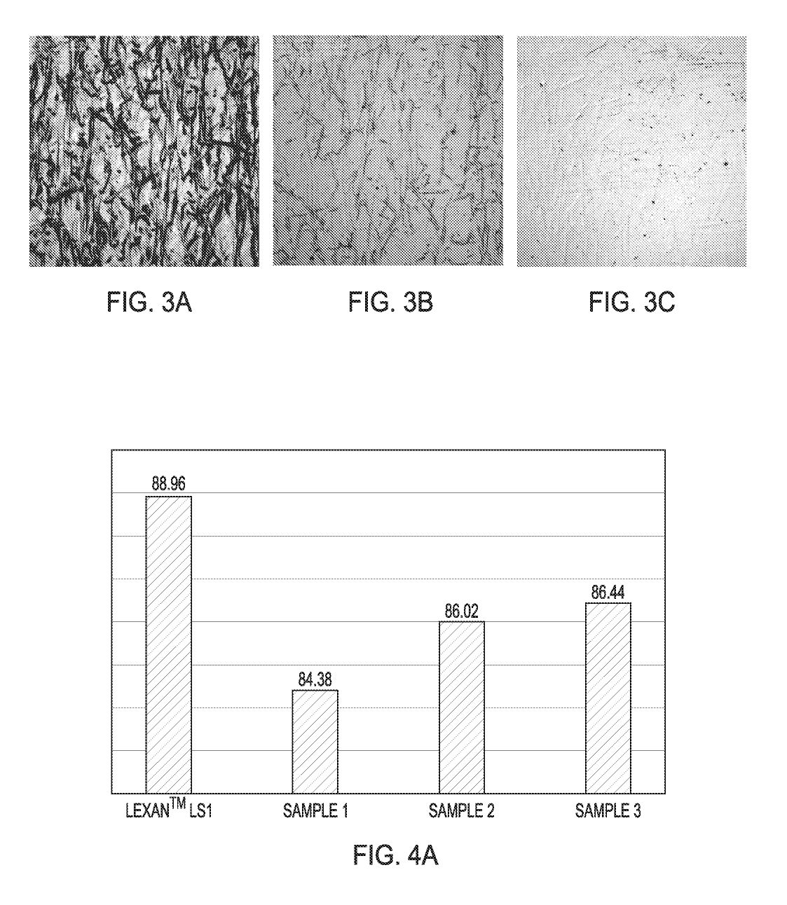

FIG. 3A is a photograph illustrating Sample 1 prepared without any heating and cooling. FIG. 3B is a photograph illustrating Sample 2 prepared with single-sided heating and cooling. FIG. 3C is a photograph illustrating Sample 3 prepared with double-sided heating and cooling.

### Example 2

### Characterization of Samples

Total transmittance, scattered transmittance, and haze was measured using an HM-150 from Murakami Color Research Laboratory, which both used a Halogen D65 (CIE standard) light source at 380 nm to 780 nm. Brightness was measured with an SR-3A supplied by Topcon, which shines a xenon light source at the sample against a white plate and detects the reflected light from the sample and from the white plate through the sample. Surface roughness was measured using a Contour Elite I from Bruker.

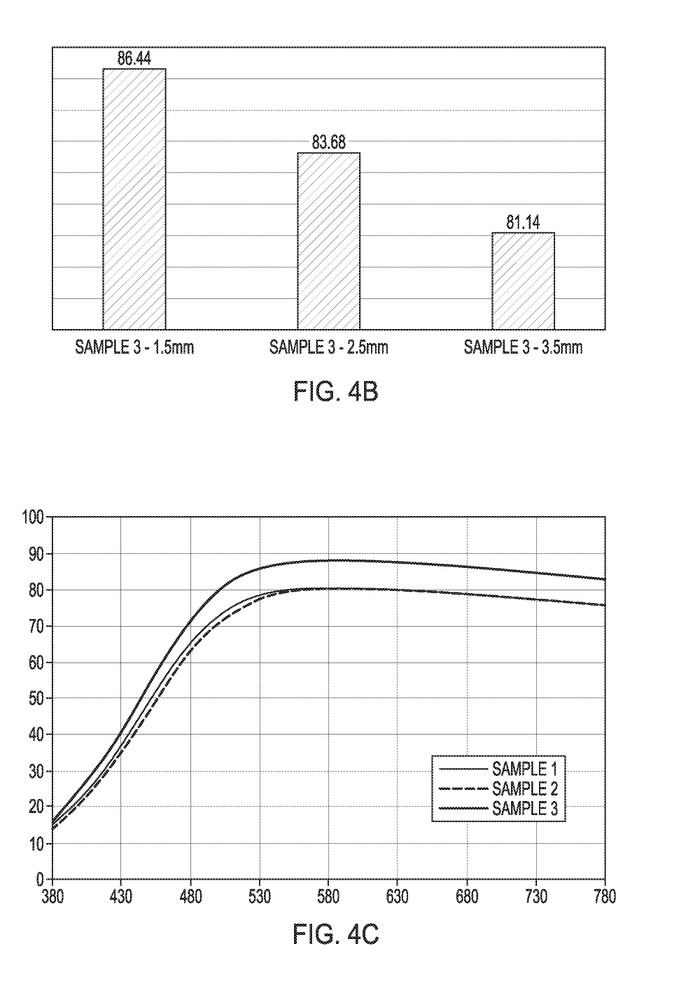

FIG. 4A illustrates total transmittance at 380-780 at 1.5 mm thickness for Samples 1-3, compared to Lexan™ LSI. Total transmittance was improved for Samples 2 and 3, with the double-sided heating and cooling of Sample 3 providing the best result. FIG. 4B illustrates total transmittance for Sample 3 at 1.5 mm, 2.5 mm, and 3.5 mm thickness. As thickness decreased, total transmittance increased. FIG. 4C illustrates the total transmittance including scattered transmittance by wavelength for Samples 1-3, which was measured using a Spectrometer U3310 from Hitachi.

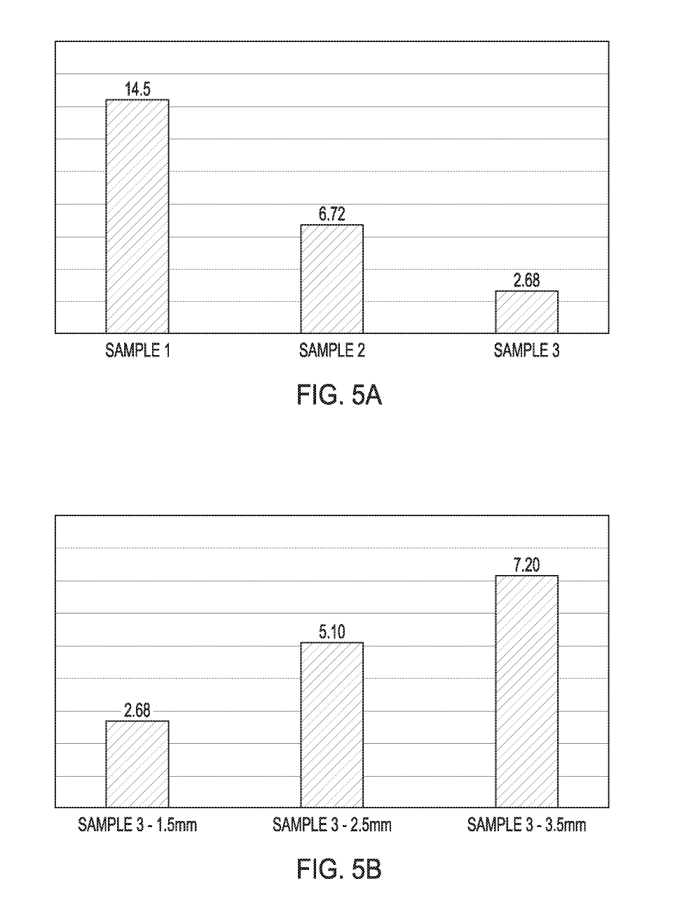

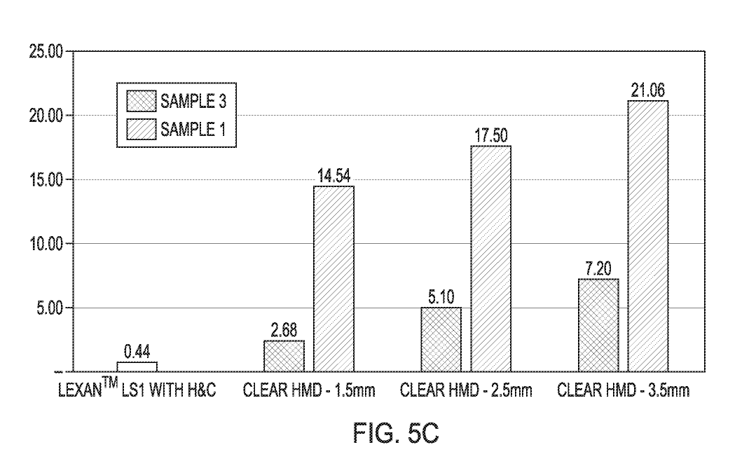

FIG. 5A illustrates scattered transmittance at 380-780 at 1.5 mm thickness for Samples 1-3. Scattered transmittance was improved for Samples 2 and 3, with the double-sided heating and cooling of Sample 3 providing the best result. FIG. 5B illustrates scattered transmittance for Sample 3 at 1.5 mm, 2.5 mm, and 3.5 mm thickness. FIG. 5C illustrates scattered transmittance at 380-780 at 1.5 mm thickness for the Lexan™ LSI Sample that was formed using heating and cooling, and for Samples 1 and 3 at 1.5 mm, 2.5 mm, and 3.5 mm thickness. As thickness decreased, scattered transmittance decreased.

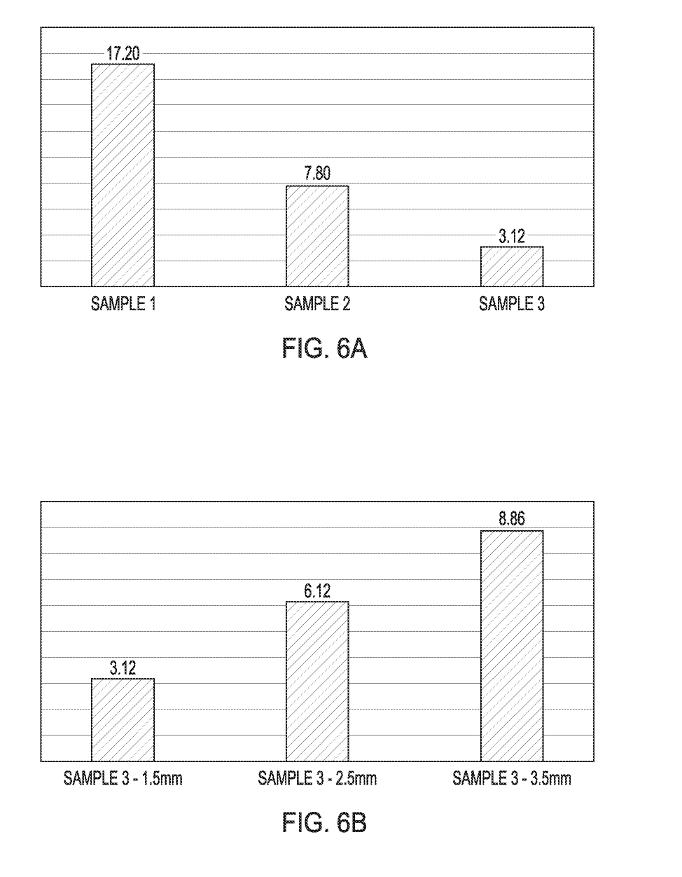

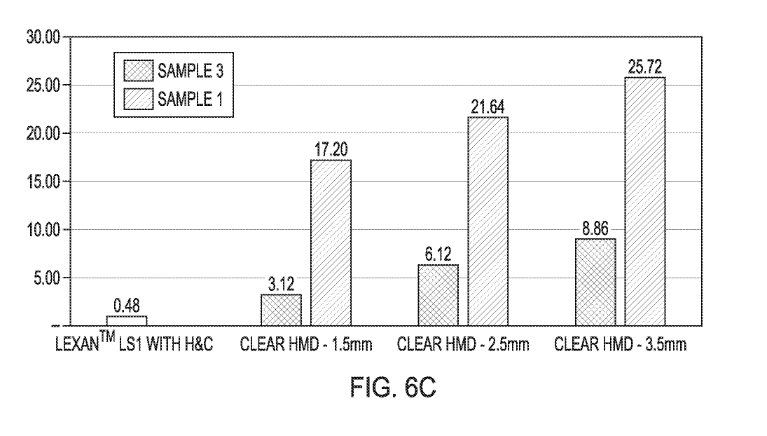

FIG. 6A illustrates haze at 380-780 at 1.5 mm thickness for Samples 1-3. Haze was improved for Samples 2 and 3, with the double-sided heating and cooling of Sample 3 providing the best result. FIG. 6B illustrates haze for Sample 3 at 1.5 mm, 2.5 mm, and 3.5 mm thickness. FIG. 6C illustrates haze for the Lexan™ LSI Sample that was formed using heating and cooling, and for Samples 1 and 3 at 1.5 mm, 2.5 mm, and 3.5 mm thickness. As thickness decreased, haze decreased.

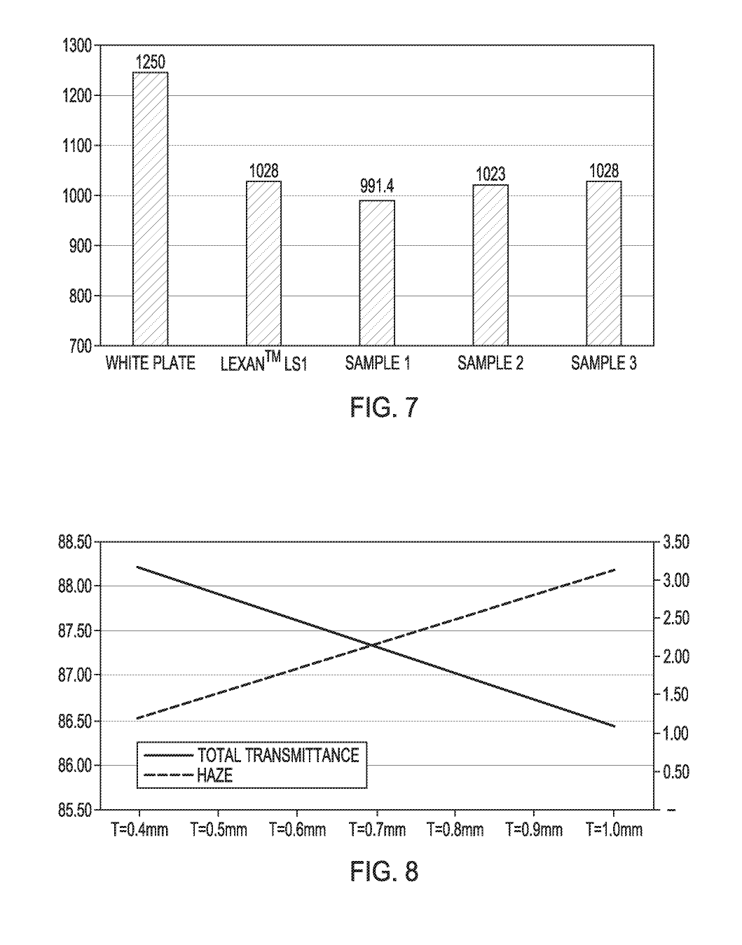

FIG. 7 illustrates the average brightness at 1.5 mm thickness for Samples 1, 2, and 3, in cd/m². Average brightness was improved for Samples 2 and 3, with the double-sided heating and cooling of Sample 3 providing the best result.

FIG. 8 illustrates calculated transmittance and haze by thickness as extrapolated from the data collected for Sample 3.

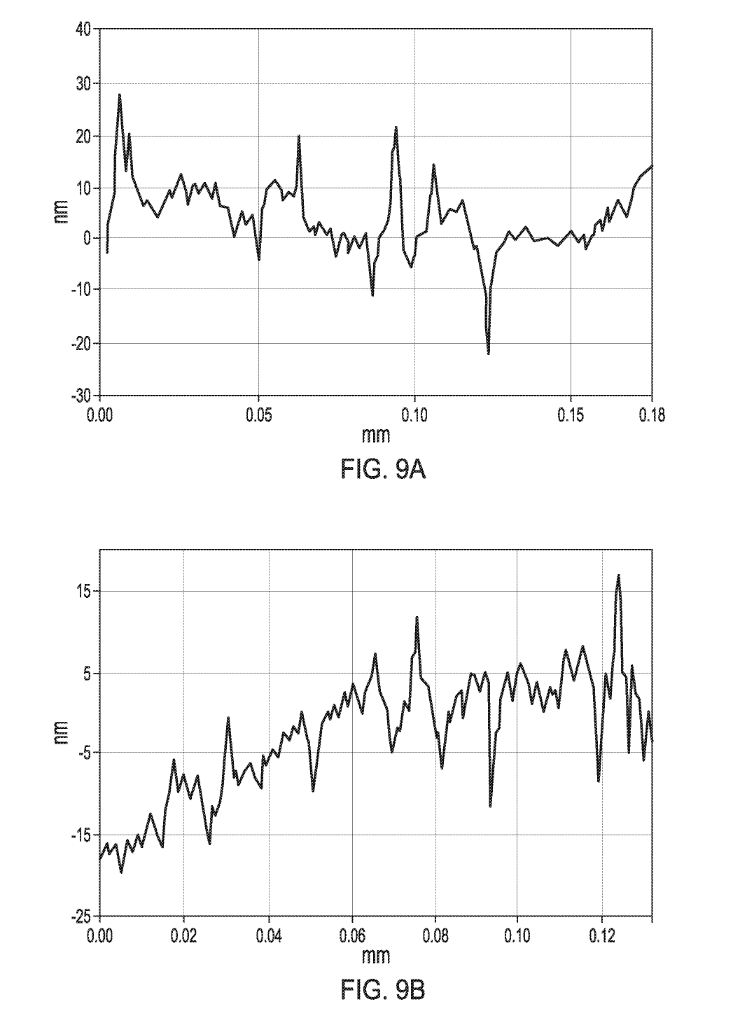

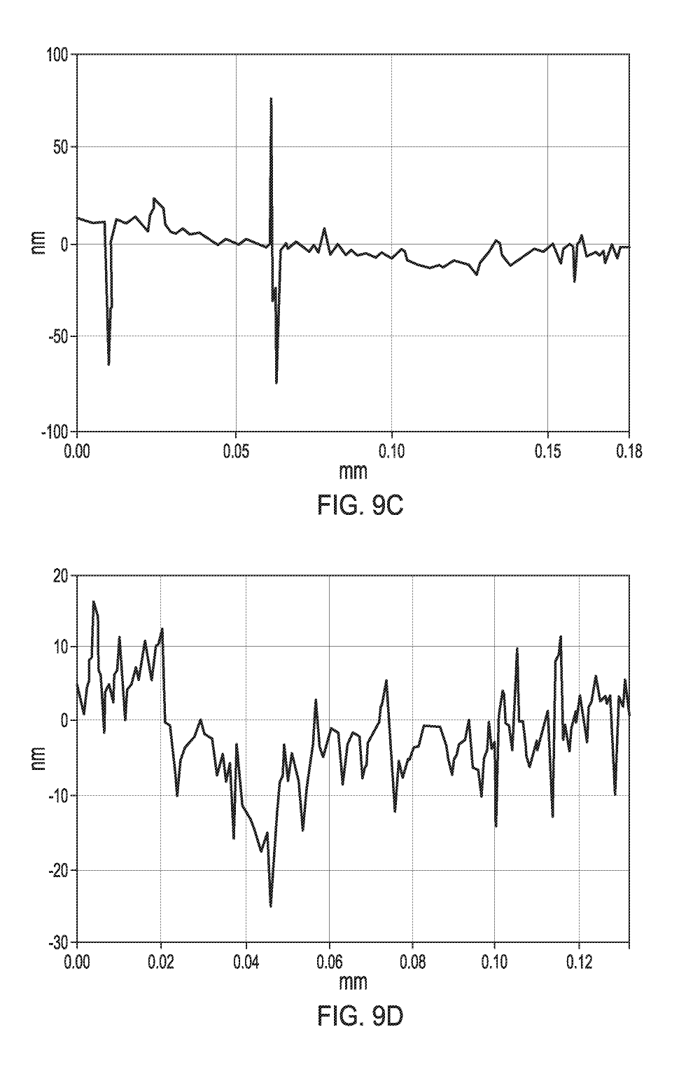

FIGS. 9A-B illustrate the surface roughness of one side of the tooling used to form Samples 1-5, with FIG. 9A showing the X-profile (ΔX=0.1763 mm, ΔZ=8.4249 nm) and with FIG. 9B (ΔX=0.1322 mm, ΔZ=18.8875 nm) showing the Y-profile, giving a surface Rₐ of 6.624 nm. FIGS. 9C-D illustrate the surface roughness of the other side of the tooling used to form Samples 1-5, with FIG. 9C showing the X-profile (ΔX=0.1763 mm, ΔZ=−15.6458 nm) and with FIG. 9D showing the Y profile (ΔX=0.1322 mm, ΔZ=2.3089 nm), giving a surface Rₐ of 6.443 nm.

Table 1 shows the Rₐ of the tooling used in these Examples.

TABLE 1
Surface Roughness (Rₐ).

| | Tooling | Sample 1 | Sample 2 | Sample 3 |
|---|---|---|---|---|
| Cavity side | 6.624 nm | 2121.173 nm | 726.07 nm | 233.838 nm |
| Core side | 6.443 nm | 1660.843 nm | 308.244 nm | 180.762 nm |

Table, 2 shows the yellow index at 570 nm for 2 mm thick samples.

TABLE 2
Yellow index.

| | Sample 1 | Sample 2 | Sample 3 |
|---|---|---|---|
| Yellow Index | 36.4 | 37.7 | 32.5 |

The Examples show that the optical performance of glass-fiber reinforced injection molded samples, such as total transmittance, scattered transmittance, haze, and brightness, were improved when the composition was injection molded with a double-sided dynamic tool temperature control system and using polished tooling.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Additional Embodiments

The following exemplary embodiments are provided, the numbering of which is not to be construed as designating levels of importance:

Embodiment 1 provides a method of making a glass filler-reinforced solid resin, comprising
contacting a flowable resin composition and a tool, wherein the flowable, resin composition comprises
   a flowable resin, and
   glass filler, wherein the glass filler and the solid resin are a substantially homogeneous mixture;
molding or forming the flowable resin composition with the tool; and
curing the flowable resin composition, to form the glass filler-reinforced solid resin;
wherein
   substantially all the surface of the tool that contacts the flowable resin compositor during the curing thereof has a surface roughness Rₐ of about 2 microns or less, and
   a refractive index of the glass filler is within about 0.100 of a refractive index of a cured product of the flowable resin in the glass filler-reinforced solid resin.

Embodiment 2 provides the method of Embodiment 1, wherein the tool comprises a surface roughness of about 0.1 nm to about 50 nm.

Embodiment 3 provides the method of any one of Embodiments 1-2, wherein the tool comprises a surface roughness of about 1 nm to about 15 nm.

Embodiment 4 provides the method of any one of Embodiments 1-3, wherein the refractive index of the glass filler is within about 0.080 of the refractive index of the cured product of the flowable resin.

Embodiment 5 provides the method of any one of Embodiments 1-4, wherein the refractive index of the glass filler is within about 0.030 of the refractive index of the cured product of the flowable resin.

Embodiment 6 provides the method of any one of Embodiments 1-5, wherein the glass filler are about 0.001 wt % to about 50 wt % of the flowable resin composition.

Embodiment 7 provides the method of any one of Embodiments 1-6, wherein the glass filler are about 5 wt % to about 40 wt % of the flowable resin composition.

Embodiment 8 provides the method of any one of Embodiments 1-7, wherein the glass filler comprise soda-lime glass, fused silica glass, borosilicate glass, lead-oxide glass, aluminosilicate glass, oxide glass, glass with high zirconia content, or a combination thereof.

Embodiment 9 provides the method of any one of Embodiments 1-8, wherein the glass filler is glass fibers that are about 0.1 mm to about 100 mm in length and about 0.1 microns to about 10 mm in diameter, or about 1 mm to about 5 mm in length to about 1 micron to about 1 mm in diameter.

Embodiment 10 provides the method of any one of Embodiments 1-9, wherein the glass filler comprises glass beads, glass flakes, glass fibers, or a combination thereof.

Embodiment 11 provides the method of any one of Embodiments 1-10, wherein the refractive index of the glass filler is about 1.450 to about 1.800.

Embodiment 12 provides the method of any one of Embodiments 1-11, wherein the refractive index of the glass filler is about 1.500 to about 1.600.

Embodiment 13 provides the method of any one of Embodiments 1-12, wherein the flowable resin is about 50 wt % to about 99.999 wt % of the flowable resin composition.

Embodiment 14 provides the method of any one of Embodiments 1-13, wherein the flowable resin is about 60 wt % to about 95 wt % of the flowable resin composition.

Embodiment 15 provides the method of any one of Embodiments 1-14, wherein the flowable resin comprises an acrylonitrile butadiene styrene (ABS) polymer, an acrylic polymer, a celluloid polymer, a cellulose acetate polymer, a cycloolefin copolymner (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene, cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PIT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN).

Embodiment 16 provides the method of any one of Embodiments 1-15, wherein the flowable resin comprises an aromatic polycarbonate and poly(1,4-cyclohexylidene cyclohexane-1,4-dicarboxylate).

Embodiment 17 provides the method of Embodiment 16, wherein the flowable resin has a weight ratio of the aromatic polycarbonate to the poly(1,4-cyclohexylidene cyclohexane-1,4-dicarboxylate) of about 30:70 to about 90:10.

Embodiment 18 provides the method of any one of Embodiments 16-17, wherein the flowable resin has a weight ratio of the aromatic polycarbonate to the poly(1,4-cyclohexylidene cyclohexane-1,4-dicarboxylate) of about 70:30 to about 60:40.

Embodiment 19 provides the method of any one of Embodiments 1-18, wherein the flowable resin comprises a bisphenol A-based polycarbonate and poly(1,4-cyclohexylidene cyclohexane-1,4-dicarboxylate).

Embodiment 20 provides the method of any one of Embodiments 1-19, wherein the refractive index of the cured product of the flowable resin is about 1.450 to about 1.800.

Embodiment 21 provides the method of any one of Embodiments 1-20, wherein the refractive index of the cured product of the flowable resin is about 1.500 to about 1.600.

Embodiment 22 provides the method of any one of Embodiments 1-21, wherein the flowable resin composition further includes a filler in addition to the glass filler.

Embodiment 23 provides the method of any one of Embodiments 1-22, wherein the tool is a roller, a press, a mold, an extruder, or a combination thereof.

Embodiment 24 provides the method of any one of Embodiments 1-23, wherein the tool is a mold.

Embodiment 25 provides the method of any one of Embodiments 1-24, wherein the contacting, molding or forming, and curing comprise injection molding, extrusion, thermal lamination, hot pressing, hot forming, or a combination thereof.

Embodiment 26 provides the method of any one of Embodiments 1-25, wherein the contacting, molding or forming, and curing comprise injection molding.

Embodiment 27 provides the method of any one of Embodiments 1-26, further comprising heating the tool prior to the contacting of the flowable resin composition and the tool, to provide a heated tool, wherein contacting the flowable resin composition and the tool comprises contacting the flowable resin composition and the heated tool.

Embodiment 28 provides the method of any one of Embodiments 1-27, further comprising cooling the tool during the molding or forming of the flowable resin composition, during the curing of the flowable resin composition, or a combination thereof.

Embodiment 29 provides the method of any one of Embodiments 1-28, wherein at least part of the surface of the tool that contacts the flowable resin composition during the curing comprises a coating.

Embodiment 30 provides the method of any one of Embodiments 1-29, wherein the glass filler-reinforced solid resin has a transmittance at 380-780 nm at 1.5 mm thickness of about 80% to about 95%.

Embodiment 31 provides the method of any one of Embodiments 1-30, wherein the glass filler-reinforced solid resin has a transmittance at 380-780 mm at 1.5 mm thickness of about 85% to about 90%.

Embodiment 32 provides the method of any one of Embodiments 1-31, wherein the glass filler-reinforced solid resin has a scattered transmittance at 380-780 nm at 1.5 mm thickness of about 0.2% to about 20%.

Embodiment 33 provides the method of any one of Embodiments 1-32, wherein the glass filler-reinforced solid resin has a scattered transmittance at 380-780 nm at 1.5 mm thickness of about 2% to about 10%.

Embodiment 34 provides the method of any one of Embodiments 1-33, wherein the glass filler-reinforced solid resin has a haze at 380-780 nm at 1.5 mm thickness of about 0.2% to about 20%.

Embodiment 35 provides the method of any one of Embodiments 1-34, wherein the glass filler-reinforced solid resin has a haze at 380-780 nm at 1.5 mm thickness of about 1% to about 15%.

Embodiment 36 provides the method of any one of Embodiments 1-35, wherein the glass filler-reinforced solid resin has a brightness at 1.5 mm thickness of about 1000 cd/m² to about 1100 cd/m².

Embodiment 37 provides the method of any one of Embodiments 1-36, wherein the glass filler-reinforced solid resin has a brightness at 1.5 nun thickness of about 1015 cd/m² to about 1050 cd/m².

Embodiment 38 provides a method of making a glass fiber-reinforced solid resin, comprising:
heating a mold;
contacting a flowable resin composition and the heated mold, wherein the flowable resin composition comprises
   a flowable resin comprising a bisphenol-A based polycarbonate and poly(1,4-cyclohexylidene cyclohexane-1,4-dicarboxylate), wherein the weight ratio of the aromatic polycarbonate to the poly(1,4-cyclohexylidene cyclohexane-1,4-dicarboxylate) is about 30:70 to about 90;10, and
   glass fibers, wherein the glass fibers and the solid resin are a substantially homogeneous mixture;
molding the flowable resin composition with the mold;
cooling the mold; and
curing the flowable resin composition, to form the glass fiber-reinforced solid resin, wherein the glass fiber-reinforced resin has
   a transmittance at 380-780 nm at 1.5 mm thickness of about 85% to about 90%,
   a scattered transmittance at 380-780 nm at 1.5 mm thickness of about 2% to about 10%,
   a haze at 380-780 nm at 1.5 mm thickness of about 1% to about 15%, and
   a brightness at 1.5 mm thickness of about 1015 cd/m² to about 1050 cd/m²;
wherein
   substantially all the surface of the tool that contacts the flowable resin composition during the curing thereof has a surface roughness Rₐ of about 1 nm to about 10 nm,
   a refractive index of the glass fibers is within about 0.100 of a refractive index of a cured product of the flowable resin in the glass fiber-reinforced solid resin, and
   the cured product of the flowable resin in the glass fiber-reinforced solid resin and the glass fibers independently have refractive indexes of about 1.500 to about 1.600.

Embodiment 39 provides a method of making a glass filler-reinforced solid resin, the method comprising:
heating a tool;
contacting a flowable resin composition and the heated tool, wherein the flowable resin composition comprises
   a flowable resin, and
   glass filler, wherein the glass filler and the solid resin are a substantially homogeneous mixture;
molding or farming the flowable resin composition with the tool;
cooling the tool; and
curing the flowable resin composition, to form the glass filler-reinforced solid resin;
wherein
   a refractive index of the glass filler is within about 0.100 of a refractive index of a cured product of the flowable resin in the glass filler-reinforced solid resin.

Embodiment 40 provides a glass filler-reinforced solid resin comprising:

a solid resin having a refractive index; and
glass filler having a refractive index, wherein the glass filler and the solid resin are a substantially homogeneous mixture, wherein the refractive index of the solid resin is within about 0.100 of the refractive index of the glass filler;
wherein the glass filler-reinforced solid resin has
   a transmittance at 380-780 nm at 1.5 mm thickness of about 80% to about 95%,
   a scattered transmittance at 380-780 nm at 1.5 mm thickness of about 0.2% to about 20%,
   a haze at 380-780 nm at 1.5 mm thickness of about 0.2% to about 20%, and
   a brightness at 1.5 mm thickness of about 1000 cd/m² to about 1100 cd/m².

Embodiment 41 provides the glass filler-reinforced solid resin of Embodiment 40, comprising a surface roughness Rₐ of about 1 nm to about 50 microns.

Embodiment 42 provides the glass filler-reinforced solid resin of any one of Embodiments 40-41, wherein the solid resin is about 50 wt % to about 99.999 wt % of the glass filler-reinforced solid resin.

Embodiment 43 provides the glass filler-reinforced solid resin of any one of Embodiments 40-42, wherein the solid resin is about 60 wt % to about 95 wt % of the glass filler-reinforced solid resin.

Embodiment 44 provides the glass filler-reinforced solid resin of any one of Embodiments 40-43, wherein the solid resin is a cured product of a flowable resin comprising an aromatic polycarbonate and poly(1,4-cyclohexylidene cyclohexane-1,4-dicarboxylate).

Embodiment 45 provides the glass filler-reinforced solid resin of any one of Embodiments 40-44, wherein the flowable resin has a weight ratio of the aromatic polycarbonate to the poly(1,4-cyclohexylidene cyclohexane-1,4-dicarboxylate) of about 30:70 to about 90:10.

Embodiment 46 provides the glass filler-reinforced solid resin of any one of Embodiments 40-45, wherein the solid resin has a refractive index of about 1.500 to about 1.600.

Embodiment 47 provides the glass filler-reinforced solid resin of any one of Embodiments 40-46, wherein the glass fiber is about 5 wt % to about 40 wt % of the glass filler-reinforced solid resin.

Embodiment 48 provides the glass filler-reinforced solid resin of any one of Embodiments 40-47, wherein the glass filler-reinforced solid resin has a transmittance at 380-780 nm at 1.5 mm thickness of about 85% to about 90%.

Embodiment 49 provides the glass filler-reinforced solid resin of any one of Embodiments 40-48, wherein the glass filler-reinforced solid resin has a scattered transmittance at 380-780 nm at 1.5 mm thickness of about 2% to about 10%.

Embodiment 50 provides the glass filler-reinforced solid resin of any one of Embodiments 40-49, wherein the glass filler-reinforced solid resin has a haze at 380-780 nm at 1.5 mm thickness of about 1% to about 15%.

Embodiment 51 provides the glass filler-reinforced solid resin of any one of Embodiments 40-50, wherein the glass filler-reinforced solid resin has a brightness at 1.5 mm thickness of about 1015 cd/m² to about 1050 cd/m².

Embodiment 52 provides a glass fiber-reinforced solid resin comprising:
a solid resin having a refractive index, the solid resin comprising a cured product of a bisphenol A-based polycarbonate and poly(1,4-cyclohexylidene cyclohexane-1,4-dicarboxylate), wherein the weight ratio of the aromatic polycarbonate to the poly(1,4-cyclohexylidene cyclohexane-1,4-dicarboxylate) in the solid resin is about 30:70 to about 90:10; and
glass fibers having a refractive index, wherein the glass fibers and the solid resin are a substantially homogeneous mixture, wherein the refractive index of the solid resin is within about 0:100 of the refractive index of the glass fibers;
wherein the solid resin and the glass fibers independently have refractive indexes of about 1.500 to about 1.600, and
wherein the glass fiber reinforced solid resin has
   a transmittance at 380-780 nm at 1.5 mm thickness of about 85% to about 90%,
   a scattered transmittance at 380-780 nm at 1.5 mm thickness of about 2% to about 10%,
   a haze at 380-780 nm at 1.5 mm thickness of about 1% to about 15%, and
a brightness at 1.5 mm thickness of about 1015 cd/m² to about 1050 cd/m².

Embodiment 52 provides the method or glass filler-reinforced solid resin of any one or any combination of Embodiments 1-51 optionally configured such that all elements or options recited are available to use or select from.

1. A method of making a glass filler-reinforced solid resin, comprising
heating a tool to provide a heated tool;
contacting a flowable resin composition and the heated tool, wherein the flowable resin composition comprises
a flowable resin comprising a bisphenol A-based polycarbonate and poly(1,4-cyclohexylidene cyclohexane-1,4-dicarboxylate), and
glass filler, wherein the glass filler and the solid resin are a substantially homogeneous mixture;
molding or forming the flowable resin composition with the heated tool;
curing the flowable resin composition, to form the glass filler-reinforced solid resin; and
cooling the heated tool during the molding or forming of the flowable resin composition, during the curing of the flowable resin composition, or a combination thereof;
wherein
substantially all the surface of the tool that contacts the flowable resin composition during the curing thereof has a surface roughness Rₐ of about 2 microns or less, and
a refractive index of the glass filler is within about 0.100 of a refractive index of a cured product of the flowable resin in the glass filler-reinforced solid resin, wherein the refractive index of the cured product of the flowable resin is about 1.450 to about 1.530 or about 1.580 to about 1.800.

2. The method of claim 1, wherein the tool comprises a surface roughness of about 1 nm to about 2 microns.

3. The method of claim 1, wherein the refractive index of the glass filler is within about 0.080 of the refractive index of the cured product of the flowable resin.

4. The method of claim 1, wherein the glass filler is about 0.001 wt % to about 50 wt % of the flowable resin composition.

5. The method of claim 1, wherein the glass filler comprises glass beads, glass flakes, glass fibers, or a combination thereof.

6. (canceled)

7. The method of claim 1, wherein the tool is a roller, a press, a mold, an extruder, or a combination thereof.

8. The method of claim 1, wherein the contacting, molding or forming, and curing comprise injection molding, extrusion, thermal lamination, hot pressing, hot forming, or a combination thereof.

9. (canceled)

10. (canceled)

11. The method of claim 1, wherein the glass filler-reinforced solid resin has a transmittance at 380-780 nm at 1.5 mm thickness of about 80% to about 95%.

12. The method of claim 1, wherein the glass filler-reinforced solid resin has a scattered transmittance at 380-780 nm at 1.5 mm thickness of about 0.2% to about 20%.

13. The method of claim 1, wherein the glass filler-reinforced solid resin has a haze at 380-780 nm at 1.5 mm thickness of about 0.2% to about 20%.

14. The method of claim 1, wherein the glass filler-reinforced solid resin has a brightness at 1.5 mm thickness of about 1000 cd/m² to about 1100 cd/m².

15. A glass filler-reinforced solid resin comprising:
a solid resin comprising a bisphenol A-based polycarbonate and poly(1,4-cyclohexylidene cyclohexane-1,4-dicarboxylate) having a refractive index; and
glass filler having a refractive index, wherein the glass filler and the solid resin are a substantially homogeneous mixture, wherein the refractive index of the solid resin is within about 0.100 of the refractive index of the glass filler;
wherein the refractive index of the solid resin is about 1.450 to about 1.530 or about 1.580 to about 1.800;
wherein the glass filler-reinforced solid resin has
a transmittance at 380-780 nm at 1.5 mm thickness of about 80% to about 95%,
a scattered transmittance at 380-780 nm at 1.5 mm thickness of about 0.2% to about 20%,
a haze at 380-780 nm at 1.5 mm thickness of about 0.2% to about 20%, and
a brightness at 1.5 mm thickness of about 1000 cd/m² to about 1100 cd/m².
